(19) United States
(12) Patent Application Publication
(10) Pub. No.: US 2022/0259444 A1
(43) Pub. Date: Aug. 18, 2022

(54) COATINGS AND PRIMERS FOR METALLIZED FILMS

(71) Applicant: SUN CHEMICAL CORPORATION, Parsippany, NJ (US)

(72) Inventors: Anthony Majszak, Northlake, IL (US); Dylan Smith, Northlake, IL (US)

(73) Assignee: SUN CHEMICAL CORPORATION, Parsippany, NJ (US)

(21) Appl. No.: 17/625,465

(22) PCT Filed: Jul. 10, 2020
(86) PCT No.: PCT/US20/41518

§ 371 Date: Jan. 7, 2022

Related U.S. Application Data
(60) Provisional application No. 62/873,216, filed on Jul. 12, 2019.

(51) Int. Cl. C09D 5/00; C09D 177/00; C09D 7/20; C09D 7/65

(52) U.S. Cl. CPC C09D 5/002; C09D 177/00; B41M 1/28; C09D 7/65; C09D 7/20

(57) ABSTRACT

The present invention provides a coating composition comprising one or more polyamide resins and one or more polyethylenimine (PEI) resins, preferably dissolved in one or more solvents. When used as a primer, the coating composition of the present invention improves adhesion of subsequently printed inks and coatings to the substrate. Advantageously, the coating composition of the present invention used as a primer improves adhesion of inks and coatings to metallized film substrates.

### CROSS REFERENCE TO RELATED APPLICATIONS

This application claims priority to U.S. Provisional Patent Appl. No. 62/873,216, filed 12 Jul. 2019, which is hereby incorporated herein in its entirety.

### FIELD OF THE INVENTION

The present invention is related to coating compositions that improve adhesion of inks and coatings to a substrate, and provide protection of the substrate. The coating compositions of the present invention can be used as a primer on a substrate to improve adhesion of subsequently printed inks and coatings. The coating compositions of the present invention comprise polyamide resins and polyethylenimine resins. The present invention is also related to a method of coating a substrate using the coating composition of the present invention. Also provided is a coated substrate comprising the coating composition of the present invention.

### BACKGROUND OF THE INVENTION

Many films (substrates) are unreceptive to ink and coating layers. Many factors of the substrate contribute to the poor adhesion of inks and coatings to substrates, such as low surface tension (typically <38 dyne/cm²), low quality initial raw materials, poor manufacturing processes, and, specifically in the case of metallized film, age and oxidation. To counteract this phenomenon, printers are often required to treat the surface of these unreceptive substrates, usually by flame or corona treatment, to increase the surface tension. But these treatment methods are time consuming and use energy that could otherwise be conserved. Furthermore, unless these treated films are used immediately after surface treatment, the dyne level can begin to decrease, creating loss of adhesion to subsequently applied inks and/or coatings.

Application of a primer on a substrate prior to printing is also a method that has been explored to improve ink adhesion to difficult substrates. These primers are generally based on materials such as polyvinyl alcohol, polyvinyl alcohol copolymers, acrylics, and polyurethanes. However, adhesion to metallized substrates, and other difficult substrates, remains a problem.

### SUMMARY OF THE INVENTION

The present invention provides a coating composition that improves adhesion of printing inks to a range of substrates. The coating compositions of the present invention comprise polyamide resins, and polyethylenimine resins. The present invention also provides methods of coating a substrate with the coating composition of the present invention, and the substrates produced by the methods.

In a particular aspect, the present invention provides a coating composition comprising:
(a) one or more polyamide resins;
(b) one or more polyethylenimine resins; and
(c) one or more organic solvents.

In another aspect, the present invention provides a printed substrate comprising the coating composition of the present invention, wherein the coating composition is the first printed layer, and is used as a primer.

In another embodiment, the present invention provides a printed substrate comprising the coating composition of the present invention, wherein the coating composition is the last printed layer, and is used as a topcoat.

In another aspect, the present invention provides a method of priming a substrate, comprising applying the coating composition of the present invention directly on the substrate as the first printed layer, and drying the coating composition on the substrate.

In another embodiment, the present invention provides a method of topcoating a substrate, comprising applying the coating composition of the present invention as the last printed layer.

These and other objects, advantages, and features of the invention will become apparent to those persons skilled in the art upon reading the details of the formulations and methods as more fully described below.

### DETAILED DESCRIPTION OF THE INVENTION

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### Definitions

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

It is to be understood that wherein a numerical range is recited, it includes the end points, all values within that range, and all narrower ranges within that range, whether specifically recited or not.

As used herein, “substrate” means any surface or object to which an ink or coating can be applied. Substrates include, but are not limited to, cellulose-based substrates, paper, paperboard, fabric, leather, textiles, felt, concrete, masonry, stone, plastic, plastic or polymer film, glass, ceramic, metal, wood, composites, combinations thereof, and the like. Substrates may have one or more layers of metals or metal oxides, or other inorganic materials. In the present invention, preferred substrates are polymer films, such as, but not limited to, polyethylene, polypropylene, oriented polypropylene (OPP), polyethylene terephthalate (PET), and the like. Polymer films with one or more layers of metals or metal oxides, i.e. metallized films, are particularly preferred.

As used herein, a “printed substrate” means a substrate to which an ink or coating has been applied and dried or cured. Methods of application include any known printing or coating method. For example, application methods include, but are not limited to, flexography, rotogravure, gravure, lithography, screen printing, curtain coating, roll coating, slot die coating, inkjet, etc. A printed substrate may include one or more layers of ink or coating, which may be the same or different from each other.

As used herein, the term “article” or “articles” means a substrate or product of manufacture. Examples of articles include, but are not limited to: substrates such as cellulose-based substrates, paper, paperboard, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metallized foil (e.g. laminated aluminum foil), metallized polyester, a metal container, and the like.

As used herein, a “coated substrate” is a print-ready substrate that is coated on one or two sides to adjust properties such as gloss, reflectivity, ink holdout, gas barrier properties, etc. For example, paper may be coated with clay or other substances to adjust gloss (e.g. matte paper, glossy paper). Polymer films are often coated with metal or metal oxide.

As used herein, a “metallized coated substrate” is a substrate coated with a metal or metal oxide. Metal coatings for metallized films include, but are not limited to, aluminum, zinc, aluminum/zinc alloy, silver/zinc alloy, nickel, chromium, and the like. In certain embodiments, the substrate is coated with aluminum.

As used herein, a “primer composition” is an ink or coating composition that is applied directly to the substrate, and upon which additional ink or coating compositions are applied.

As used herein, “topcoat composition” and “overprint varnish” are used interchangeably, and refer to an ink or coating composition that is applied as the last down layer. A topcoat or overprint varnish may be applied directly to a substrate as the only coating or ink layer. Or, a topcoat or overprint varnish may be applied over top of previously printed inks or coatings.

As used herein, a “printed layer” means an ink or coating that has been applied to a substrate. A “first printed layer” refers to an ink or coating that is applied directly to the substrate. Subsequently printed layers (e.g. “second printed layer”, “third printed layer”, etc.) refer to inks or coatings that are applied on top of previously printed layers. A “last printed layer” refers to an ink or coating that is applied last, and upon which no further printed layers are applied. A printed layer may be the coating composition of the present invention, or any other ink or coating composition.

Throughout this disclosure, all parts and percentages are by weight (wt % or mass % based on the total weight) and all temperatures are in ° C. unless otherwise indicated.

### Coating Composition

One solution for achieving satisfactory adhesion of inks on problematic substrates is to apply a first-down primer to provide anchoring for subsequent layers of printing inks and coating. In a preferred embodiment of the present invention, a first down primer would be applied to a metallized film that would otherwise be unreceptive to subsequent ink and coating layers, unless it was first treated (e.g. flame or corona treatment). In a more preferred embodiment, the film would be an aluminum metallized film. However, the present invention is not limited to just these embodiments, and could also be used as a primer coating on other metallized films, as well as non-metallized films.

The coating compositions of the present invention would preferably be used as primer on metallized films (e.g. metallized PET and OPP films) to which inks and coatings would not typically adhere. In a preferred embodiment, the film would be aluminum metallized film. In a further embodiment, the film would be a non-metallized film to which inks and coatings would not typically adhere. The coating composition could also be used as a topcoat for films that may not be otherwise overprinted with subsequent overlying ink and/or coating layers. The coating compositions of the invention could also be used as topcoat or overprint varnish on top of printed inks on the films. The coating compositions of the invention are suitable to be applied as primers to metallized cast polypropylene, PET and OPP films, and non-metallized OPP, PET, and polyethylene films. In each case, the coating compositions as a primer impart passing ink adhesion, whereas the ink alone exhibits failing adhesion.

A common use of metallized film is food packaging with minimal ink coverage, such as coffee bags or pop tarts. Most of the package has the appearance of unprinted metallized film, with very low ink coverage. The metallized film is used metal side out, and is prone to scuffing, sticking or sliding, etc. Thus, scuff protection and/or adjustment of coefficient of friction may be required. Use of the coating composition of the present invention provides both scuff protection, and adjustment of coefficient of friction to meet industry standards. For example, in a fingernail scratch evaluation (a fingernail rubbed back and forth across the surface of the substrate with medium pressure) we saw that the aluminum was rubbed away quite easily with 4-5 rubs. When a coating composition of the invention was used as a printed layer on the aluminum coated substrate, under the same fingernail rub evaluation, the aluminum was protected and was not rubbed away. The coating composition of the invention can achieve these results when used as a primer applied to the substrate, over which inks and additional coatings can be applied. Or, the coating composition can be used as the only coating, with no additional ink or coating layers.

The coating composition of the present invention comprises one or more polyamide resins and one or more polyethylenimine (PEI) resins. In preferred embodiments, the resins are dissolved in a solvent solution. The solvent solution may comprise one or more solvents.

Suitable polyamide resins include, but are not limited to, Unirez 2215 and Unirez 2248 (both from Kraton Corporation), and the like.

Polyamide resins are typically present in the coating compositions of the present invention in an amount of 10 wt % to 60 wt % resin solids, based on the total weight of the coating composition. For example, the polyamide resins may be present in an amount of about 10 wt % to 55 wt %, based on the total weight of the coating composition; or about 10 wt % to about 50 wt %; or about 10 wt % to about 45 wt %; or about 10 wt % to about 40 wt %; or about 10 wt % to about 35 wt %; or about 10 wt % to about 30 wt %; or about 10 wt % to about 25 wt %; or about 10 wt % to about 20 wt %; or about 10 wt % to about 15 wt %; or about 15 wt % to about 60 wt %; or about 15 wt % to about 55 wt %; or about 15 wt % to about 50 wt %; or about 15 wt % to about 45 wt %; or about 15 wt % to about 40 wt %; or about 15 wt % to about 35 wt %; or about 15 wt % to about 30 wt %; or about 15 wt % to about 25 wt %; or about 15 wt % to about 20 wt %; or about 20 wt % to about 60 wt %; or about 20 wt % to about 55 wt %; or about 20 wt % to about 50 wt %; or about 20 wt % to about 45 wt %; or about 20 wt % to about 40 wt %; or about 20 wt % to about 35 wt %; or about 20 wt % to about 30 wt %; or about 20 wt % to about 25 wt %; or about 25 wt % to about 60 wt %; or about 25 wt % to about 55 wt %; or about 25 wt % to about 50 wt %; or about 25 wt % to about 45 wt %; or about 25 wt % to about 40 wt %; or about 25 wt % to about 35 wt %; or about 25 wt % to about 30 wt %; or about 30 wt % to about 60 wt %; or about 30 wt % to about 55 wt %; or about 30 wt % to about 50 wt %; or about 30 wt % to about 45 wt %; or about 30 wt % to about 40 wt %; or about 30 wt % to about 35 wt %; or about 35 wt % to about 60 wt %; or about 35 wt % to about 55 wt %; or about 35 wt % to about 50 wt %; or about 35 wt % to about 45 wt %; or about 35 wt % to about 40 wt %; or about 40 wt % to about 60 wt %; or about 40 wt % to about 55 wt %; or about 40 wt % to about 50 wt %; or about 40 wt % to about 45 wt %; or about 45 wt % to about 60 wt %; or about 45 wt % to about 55 wt % or about 45 wt % to about 50 wt %; or about 50 wt % to about 60 wt %; or about 50 wt % to about 55 wt %; or about 55 wt % to about 60 wt %. In one embodiment, the polyamide resins are present in an amount of about 15 wt % to about 40 wt %, based on the total weight of the coating composition.

Suitable polyethylenimine resins include, but are not limited to, Polymin P water free and Lupasol FT WF (both from BASF), and the like.

The polyethylenimine resins are typically present in an amount of about 0.5 wt % to about 10 wt % resin solids, based on the total weight of the coating composition. For example, the polyethyleneimine resins may be present in an amount of about 0.5 wt % to about 9.5 wt %, based on the total weight of the coating composition; or about 0.5 wt % to about 9 wt %; or about 0.5 wt % to about 8 wt %; or about 0.5 wt % to about 7 wt %; or about 0.5 wt % to about 6 wt %; or about 0.5 wt % to about 5 wt %; or about 0.5 wt % to about 4 wt %; or about 0.5 wt % to about 3 wt %; or about 0.5 wt % to about 2 wt %; or about 0.5 wt % to about 1 wt %; or about 1 wt % to about 10 wt %; or about 1 wt % to about 9 wt %; or about 1 wt % to about 8 wt %; or about 1 wt % to about 7 wt %; or about 1 wt % to about 6 wt %; or about 1 wt % to about 5 wt %; or about 1 wt % to about 4 wt %; or about 1 wt % to about 3 wt %; or about 1 wt % to about 2 wt %; or about 2 wt % to about 10 wt %; or about 2 wt % to about 9 wt %; or about 2 wt % to about 8 wt %; or about 2 wt % to about 7 wt %; or about 2 wt % to about 6 wt %; or about 2 wt % to about 5 wt %; or about 2 wt % to about 4 wt %; or about 2 wt % to about 3 wt %; or about 3 wt % to about 10 wt %; or about 3 wt % to about 9 wt %; or about 3 wt % to about 8 wt %; or about 3 wt % to about 7 wt %; or about 3 wt % to about 6 wt %; or about 3 wt % to about 5 wt %; or about 3 wt % to about 4 wt %; or about 4 wt % to about 10 wt %; or about 4 wt % to about 9 wt %; or about 4 wt % to about 8 wt %; or about 4 wt % to about 7 wt %; or about 4 wt % to about 6 wt %; or about 4 wt % to about 5 wt %; or about 5 wt % to about 10 wt %; or about 5 wt % to about 9 wt %; or about 5 wt % to about 8 wt %; or about 5 wt % to about 7 wt %; or about 5 wt % to about 6 wt %; or about 6 wt % to about 10 wt %; or about 6 wt % to about 9 wt %; or about 6 wt % to about 8 wt %; or about 6 wt % to about 7 wt %; or about 7 wt % to about 10 wt %; or about 7 wt % to about 9 wt %; or about 7 wt % to about 8 wt %; or about 8 wt % to about 10 wt %; or about 8 wt % to about 9 wt %; or about 9 wt % to about 10 wt %. In certain embodiments, the coating compositions of the invention comprise 0.5 wt % to 5 wt % PEI resin solids, or 0.5 wt % to 3 wt % PEI resin solids, based on the total weight of the coating composition. In preferred embodiments, the amount of PEI present in the coating composition of the present invention does not exceed 2.5 wt % based on the total weight of the coating composition.

The ratio of the amount of the polyamide resin to the PEI resin affects the performance of the coating compositions. If the amount of PEI is too high, adhesion of the coating to the substrate, and subsequently printed inks and coatings, is reduced. Typically, the ratio of polyamide : PEI is preferably in the range of 99.1:0.1 to 85:15, based on the total weight of the resins. Preferably, a maximum of 12 wt % PEI, based on the total weight of the resins (non-volatile content) is used in the coating compositions of the present invention.

The polyamide and PEI resins are typically dissolved in a solvent solution comprising one or more solvents. Suitable solvents in the solvent solution include, but are not limited to, water, alcohols, esters, ketones, and the like. Preferably the alcohols contain 1 to 10 carbon atoms. For example, suitable alcohols include, but are not limited to, normal propanol or ethanol. Ester solvents may include, but are not limited to, ethyl acetate and normal propyl acetate, to help control wet-out, dry speed and other application properties. The solvent solution may contain one solvent, or a combination of solvents.

The solvent solution is typically present in an amount of about 25 wt % to about 65 wt %, based on the total weight of the coating composition. For example, the solvent solution may be present in an amount of about 25 wt % to about 60 wt %, based on the total weight of the coating composition; or about 25 wt % to about 55 wt %; or about 25 wt % to about 50 wt %; or about 25 wt % to about 45 wt %; or about 25 wt % to about 40 wt %; or about 25 wt % to about 35 wt %; or about 25 wt % to about 30 wt %; or about 30 wt % to about 65 wt %; or about 30 wt % to about 60 wt %; or about 30 wt % to about 55 wt %; or about 30 wt % to about 45 wt %; or about 30 wt % to about 40 wt %; or about 30 wt % to about 35 wt %; or about 35 wt % to about 65 wt %; or about 35 wt % to about 60 wt %; or about 35 wt % to about 55 wt %; or about 35 wt % to about 50 wt %; or about 35 wt % to about 45 wt %; or about 35 wt % to about 40 wt %; or about 40 wt % to about 65 wt %; or about 40 wt % to about 60 wt %; or about 40 wt % to about 55 wt %; or about 40 wt % to about 50 wt %; or about 40 wt % to about 45 wt %; or about 45 wt % to about 65 wt %; or about 45 wt % to about 60 wt %; or about 45 wt % to about 55 wt %; or about 45 wt % to about 50 wt %; or about 50 wt % to about 65 wt %; or about 50 wt % to about 60 wt %; or about 50 wt % to about 55 wt %; or about 55 wt % to about 65 wt %; or about 55 wt % to about 60 wt %; or about 60 wt % to about 65 wt %. In certain embodiments, the solvent solution is present in an amount of 35 wt % to 60 wt %, based on the total weight of the coating composition. In certain embodiments, the solvent solution does not contain any acetates (i.e. 0 wt %). When acetates are present in the solvent solution, it is preferable that they are present in an amount of 0.1 wt % to 30 wt %, based on the total weight of the coating composition.

In preferred embodiments, the coating compositions of the present invention would meet industry specific properties, such as coefficient of friction and scuff resistance. The use of flexible materials in many industries requires a specific Coefficient of Friction (CoF) on the outside or the inside of the material. CoF is the ratio between the force necessary to move one surface horizontally over another, and the pressure between the two surfaces. A passing result in the CoF test (i.e. the CoF value) is determined based on the CoF that is required by the specific end use. To help impart these properties, surface modifiers, such as polyethylene, polypropylene, or polytetrafluoroethylene (PTFE) waxes may optionally be added to the coating compositions of the invention. Other suitable waxes include, but are not limited to, amide wax, erucamide wax, paraffin wax, carnuba wax, and the like. The wax may be one wax or a combination of different waxes. In certain embodiments, the coating compositions of the present invention contain no wax. When waxes are present, they are typically present in an amount of about 0.1 wt % to about 10 wt %, based on the total weight of the coating composition. For example, the wax may be present in an amount of about 0.1 wt % to about 9 wt %; or about 0.1 wt % to about 8 wt %; or about 0.1 wt % to about 7 wt %; or about 0.1 wt % to about 6 wt %; or about 0.1 wt % to about 5 wt %; or about 0.1 wt % to about 4 wt %; or about 0.1 wt % to about 3 wt %; or about 0.1 wt % to about 2 wt %; or about 0.1 wt % to about 1 wt %. In certain embodiments, waxes are present in an amount of about 0.1 wt % to about 4 wt %, based on the total weight of the coating composition.

Although the coating compositions of the present invention would generally not contain colorant, in certain embodiments they may contain one or more colorants. The colorant may be any dye or pigment that can be used in printing inks. The colorant may be a dye or a pigment. Examples of useable colorants include, but are not limited to, inorganic pigments, such as Pigment White 6 (Titanium Dioxide), Pigment Black 7 (carbon black), Pigment Black 11 (Black Iron Oxide), Pigment Red 101 (Red Iron Oxide) and Pigment Yellow 42 (Yellow Iron Oxide), and organic pigments such as Pigment Yellow 1, Pigment Yellow 3, Pigment Yellow 12, Pigment Yellow 13, Pigment Yellow 14, Pigment Yellow 17, Pigment Yellow 37, Pigment Yellow 63, Pigment Yellow 65, Pigment Yellow 73, Pigment Yellow 74, Pigment Yellow 75, Pigment Yellow 83, Pigment Yellow 97, Pigment Yellow 98, Pigment Yellow 106, Pigment Yellow 114, Pigment Yellow 121, Pigment 26Yellow 126, Pigment Yellow 136, Pigment Yellow 174, Pigment Yellow 176, Pigment Yellow 188, Pigment Orange 5, Pigment Orange 13, Pigment Orange 16, Pigment Orange 34, Pigment Red 2, Pigment Red 9, Pigment Red 14, Pigment Red 17, Pigment Red 22, Pigment Red 23, Pigment Red 37, Pigment Red 38, Pigment Red 41, Pigment Red 42, Pigment Red 112, Pigment Red 146, Pigment Red 170, Pigment Red 196, Pigment Red 210, Pigment Red 238, Pigment Blue 15, Pigment Blue 15:1, Pigment Blue 15:2, Pigment Blue 15:3, Pigment Blue 15:4, Pigment Green 7, Pigment Green 36, Pigment Violet 23 and the like. The dyes include but are not limited to azo dyes, anthraquinone dyes, xanthene dyes, azine dyes, combinations thereof, and the like.

In certain embodiments, you want the coating composition to appear clear under normal viewing conditions (e.g. ambient light), while being able to confirm that the coating is present on the substrate, or that there is correct registration of the coating to the substrate. For example, it is often difficult to tell if a metallized film has a coating because uncoated and coated metallized film typically looks very similar. One way of doing this is to include UV active pigments and dyes (e.g. “optical brighteners”) that are not visible under normal viewing conditions, but absorb light in the ultraviolet range, and emit light in the visible range. When viewed under an ultraviolet light, the coating on the substrate will be visible.

When used, colorants are typically present in the coating composition in an amount of about 0.1 wt % to about 20 wt %, based on the total weight of the coating composition. For example, the colorants may be present in an amount of about 0.1 wt % to about 15 wt %, based on the total weight of the coating composition; or about 0.1 w% to about 10 wt %; or about 0.1 wt % to about 5 wt %; or about 0.1 wt % to about 1 wt %; or about 0.1 wt % to about 0.5 wt %. In certain embodiments, optical brighteners are present in an amount of about 0.1 wt %.

As with most ink and coating compositions, the coating compositions of the present invention may incorporate additives to enhance various properties. A partial list of such additives includes, but is not limited to, adhesion promoters, silicones, light stabilizers, de-gassing additives, ammonia, flow promoters, defoamers, antioxidants, stabilizers, surfactants, dispersants, plasticizers, rheological additives, waxes, silicones, extender pigments, and the like. In certain embodiments, the coating compositions of the invention do not contain additives. In other embodiments, the coating compositions of the invention comprise one or more additives. When present, the additives are typically each individually present in an amount of about 0.1 wt % to 5 wt %, based on the total weight of the coating composition.

The coating composition would typically be supplied in liquid form under most ambient conditions where printing is carried out. When the coating composition is used as a primer, subsequently applied layers of inks and/or coatings that would not adhere to the bare substrate surface can be applied over the primer, and then exhibit good adhesion, as measured by standard testing methods. Suitable methods for application of the coating composition, for example as a primer, include, but are not limited to, flexography, rotogravure, lithographic, screen, and other coating methods used in industry. There is no limitation as to how the subsequently applied ink or coating layers are applied over the top of the primer.

### EXAMPLES

The following examples illustrate specific aspects of the present invention, and are not intended to limit the scope thereof in any respect, and should not be so construed.

### Methods

### Printing

Primers, inks, and overprint varnishes were applied to a metallized substrate. Primers, inks and overprint varnishes were applied flexographically with a bladed anilox hand proofer using an anilox cylinder with rubber roller to the aluminum side of metallized polypropylene film. Two types of metallized cast polypropylene film were used, Met A and Met B. After application, the primer was dried at 120° F. (48.89° C.) for 5 seconds and allowed to cool at room temperature (about 75° F. (23.89° C.)) for five minutes. Dry film weight was about 0.81 g/m² (0.5 lb/ream).

### Adhesion

The adhesion of the dried primers, inks, and overprint varnish to the substrate was tested using the tape adhesion test. A strip of Scotch 610 tape was pressed on the surface of the dried composition. The strip was pulled off abruptly, at an angle of approximately 90 degrees. A passing result was recorded when the composition remained anchored to the surface with minimal (“picking”) or no removal. Assessed numerically, no removal was graded as a 10; picking was graded as a 9; complete removal was graded as a 1; with the intervening scores representing intermediate removal. For the purposes of the present invention, anything below a 9 was considered a failing result.

### Coefficient of Friction

Coefficient of Friction (CoF) was determined using the TMI Static/Kinetic CoF Tester Model 32-07-00-0001. Static and kinetic CoF were measured.

### Examples 1 to 3. Primer Compositions Comprising Polyamide Resins and Polyethylenimine Resins

Three primer compositions comprising polyamide resin and polyethylenimine resin were prepared, Examples 1, 2, and 3. The formulations of Examples 1, 2, and 3 are shown in Table 1.

TABLE 1
Formulations of Examples 0, 1, and 2

| Material | Ex. 1 (wt %) | Ex. 2 (wt %) | Ex. 3 (wt %) |
|---|---|---|---|
| UNI-REZ 2215 polyamide | 35.0 | 35.0 | 35.0 |
| Polyethylenimine | 0.5 | 2.0 | 2.0 |
| PTFE wax | 0.0 | 1.0 | 0.0 |
| n-propyl alcohol/n-propyl | 64.5 | 62.0 | 63 |
| acetate blend | | | |
| Total | 100 | 100 | 100 |

The polyamide and polyethylenimine resins were mixed in a blend of alcohol and ester until dissolved, to provide a primer composition. If necessary, the viscosity of the primer was adjusted to be suitable for flexographic application of about 45 cP to about 65 cP (i.e. about 25-30 sec. #2EZ Zahn cup).

### Example 4. Commercially Available Ink

Pyroflex Green CHOFS0031121 polyurethane/nitrocellulose ink (Sun Chemical).

### Example 5. Overprint Varnish

CHOFS0031121 HR OPV plasticized nitrocellulose overprint varnish.

### Examples 6 to 8. Comparative Primers

Ex. 6: CHSFW0831473:HYDRO OPTBRITE PRIMER:D947 styrene acrylic emulsion-based coating (Sun Chemical).

Ex. 7: V-71955:PRO-PLY PRIMER) polyethyleneimine diluted in solvent (Sun Chemical).

Ex. 8: CHKFS0090494:PROKOTE PRIMER:K529 ethyl methacrylate and polyethyleneimine based coating (Sun Chemical).

### Example 9. Adhesion Testing

Examples 1 to 8 were applied to the substrate in various configurations, as described in Table 2. The adhesion of the printed substrates was tested as described above. First down layer (i.e. the first printed layer) is listed first, and subsequent layers listed in order of application. Thus, for example, Ex. 4 ink (no primer)+Ex. 5 OPV means that the Ex. 4 ink is printed directly on the substrate, and the Ex. 5 OPV is applied on top of the Ex. 4 ink.

TABLE 2
Adhesion

| Print | | Adhesion Rating | |
|---|---|---|---|
| Config. | | Met film | Met film |
| # | Print Configuration Layer Details | A | B |
| 1 | Ex. 4 ink (no primer) | 1 | 1 |
| 2 | Ex. 4 ink (no primer) + Ex. 5 OPV | 1 | 1 |
| 3 | Ex. 1 primer | 10 | 8 |
| 4 | Ex. 1 primer + Ex. 4 ink | 10 | 7 |
| 5 | Ex. 1 primer + Ex. 4 ink + Ex. 5 OPV | 10 | 7 |
| 6 | Ex. 2 primer | 10 | 10 |
| 7 | Ex. 2 primer + Ex. 4 ink | 10 | 10 |
| 8 | Ex. 2 primer + Ex. 4 ink + Ex. 5 OPV | 10 | 10 |
| 9 | Ex. 3 primer | 10 | 10 |
| 10 | Ex. 3 primer + Ex. 4 ink | 10 | 10 |
| 11 | Ex. 3 primer + Ex. 4 ink + Ex. 5 OPV | 10 | 10 |
| 12 | Ex. 6 primer | 1 | 1 |
| 13 | Ex. 6 primer + Ex. 4 ink | 1 | 1 |
| 14 | Ex. 6 primer + Ex. 4 ink + Ex. 5 OPV | 1 | 1 |
| 15 | Ex. 7 primer | 5 | 2 |
| 16 | Ex. 7 primer + Ex. 4 ink | 4 | 2 |
| 17 | Ex. 7 primer + Ex. 4 ink + Ex. 5 OPV | 4 | 1 |
| 18 | Ex. 8 primer | 8 | 4 |
| 19 | Ex. 8 primer + Ex. 4 ink | 7 | 3 |
| 20 | Ex. 8 primer + Ex. 4 ink + Ex. 5 OPV | 5 | 1 |

The data in Table 2 clearly show that inventive primers Ex. 1 to 3 (configuration numbers 3, 6, and 9) exhibited much better adhesion to the substrate than the comparative primers Ex. 6 to 8 (configuration numbers 12, 15, and 18). In addition, inventive primers Ex. 1 to 3 improved adhesion of a polyurethane/nitrocellulose ink (Ex. 4) to the substrate (configuration numbers 4, 7, and 10), whereas the comparative primers 6 to 8 did not (configuration numbers 13, 16, and 19). Inventive primers Ex. 1 to 3 also improved adhesion of Ex. 4 ink overprinted with overprint varnish Ex. 5 to the substrate (configuration numbers 5, 8, and 11), compared to comparative primers Ex. 6 to 8 (configuration numbers 14, 17, and 20).

### Example 10. Coefficient of Friction (CoF) Testing

Adjustment of CoF by application of Ex. 2 primer, with and without overprinting with Ex. 4 ink, was tested as described above. The substrate was Met B, and the primer and ink were applied to the metal side. The Ex. 4 ink was applied to the substrate as a 5% coverage dot pattern. The results are shown in Table 3.

TABLE 3
Coefficient of Friction

| | Coefficient of Friction (CoF) | |
|---|---|---|
| Print Configuration Layer Details | Static | Kinetic |
| Bare film (metal side) | 0.512 | 0.445 |
| Ex. 2 primer | 0.427 | 0.335 |
| Ex. 2 primer + Ex. 4 ink | 0.418 | 0.327 |

As can be seen from the results in Table 3, applying the Ex. 2 primer adjusted CoF to within acceptable industry standards for kinetic CoF of 0.30 to 0.40. The kinetic CoF of the bare film was too high.

The present invention has been described in detail, including the preferred embodiments thereof. However, it will be appreciated that those skilled in the art, upon consideration of the present disclosure, may make modifications and/or improvements on this invention that fall within the scope and spirit of the invention.

1. A coating composition comprising:
a) one or more polyamide resins;
b) one or more polyethylenimine resins; and
c) one or more organic solvents;
wherein the ratio of polyamide resin to polyethylenimine resin is 99.9:0.1 to 85:15, based on the total weight of the resins.

2. The coating composition of claim 1, wherein at least one organic solvent is an alcohol.

3. The coating composition of claim 1, wherein at least one organic solvent is an ester solvent.

4. The coating composition of claim 1, comprising at least one alcohol solvent, and at least one ester solvent.

5. The coating composition of claim 1, further comprising one or more waxes.

6. The coating composition of claim 5, wherein the one or more waxes are each independently selected from the group consisting of polyethylene wax, polypropylene wax, polytetrafluoroethylene (PTFE) wax, amide wax, erucamide wax, paraffin wax, carnuba wax, and combinations thereof.

7. The coating composition of claim 1, comprising:
a) 10 wt % to 60 wt % one or more polyamide resins, based on the total weight of the primer composition;
b) 0.5 wt % to 10 wt % one or more polyethylenimine resins, based on the total weight of the primer composition.
c) 25 wt % to 65 wt % one or more organic solvents, based on the total weight of the primer composition; and
d) no wax (0 wt %), or, when present, 0.1 wt % to 4 wt % one or more waxes, based on the total weight of the primer composition.

8. (canceled)

9. The coating composition of claim 1, wherein the coating composition is a primer composition.

10. The coating composition of claim 1, wherein the coating composition is a topcoat composition.

11. A method of priming a substrate, the method comprising:
a) providing a substrate;
b) providing the coating composition of 1, wherein the coating composition is a primer composition;
c) applying one or more layers of the coating composition as the first printed layer on the substrate; and
d) drying the coating composition on the substrate to provide a primed substrate.

12. The method of claim 11, wherein the coating composition is applied as a flood coat, covering the entirety of the substrate surface.

13. The method of claim 11, wherein the coating composition is applied selectively to less than the entirety of the substrate surface.

14. The method of claim 11, wherein the substrate is a coated substrate.

15. The method of claim 14, wherein the coated substrate is a metallized coated substrate.

16. The method of claim 14, wherein the coated substrate is an aluminum metalized coated substrate.

17. A primed substrate prepared by the method of claim 11.

18. An article comprising the primed substrate of claim 17.

19. A method of topcoating a substrate, the method comprising:
a) providing a substrate;
b) optionally applying one or more layers of an ink or coating as first printed layer, and/or subsequently printed layers;
c) providing the coating composition of claim 1, wherein the coating composition is a topcoat composition;
d) applying one or more layers of the coating composition as the last printed layer on the substrate; and
e) drying the coating composition on the substrate to provide a topcoated substrate.

20. The method of claim 19, wherein the coating composition is applied as a flood coat, covering the entirety of the substrate surface.

21. The method of claim 19, wherein the coating composition is applied selectively to less than the entirety of the substrate surface.

22. The method of claim 19, wherein the substrate is a coated substrate.

23. The method of claim 22, wherein the coated substrate is a metallized coated substrate.

24. The method of claim 22, wherein the coated substrate is an aluminum metalized coated substrate.

25. A topcoated substrate prepared by the method of claim 19.

26. An article comprising the topcoated substrate of claims 25.
